(19) United States
(12) Patent Application Publication
(10) Pub. No.: US 2016/0292649 A1
(43) Pub. Date: Oct. 6, 2016

(54) Computerized System and Method for Conditionally Sharing Calendars with Referring Providers

(71) Applicant: APPLIED RESEARCH WORKS Inc., Palo Alto, CA (US)

(72) Inventors: SHAIBAL ROY, PALO ALTO, CA (US); Yin Ling Leung, Palo Alto, CA (US)

(73) Assignee: APPLIED RESEARCH WORKS INC., Palo Alto, CA (US)

(21) Appl. No.: 14/675,597

(22) Filed: Mar. 31, 2015

(51) Int. Cl. G06Q 10/10

(52) U.S. Cl. CPC G06Q 10/1095

(57) ABSTRACT

Disclosed is a computerized system and method for conditionally sharing calendars between providers and managing referrals. The method comprises the steps of supplying a user name and a password to a first provider though a computer network; creating an account associated with the first provider and storing data associated with the account associated with the first user on a central repository; supplying a user name and password to a second provider through the computer network; creating an account associated with the second provider and storing data associated with the account associated with the second user on the central repository; obtaining, through the computer network, criteria established by the second user that must be satisfied for the for the first provider to view a calendar of the second provider; determining the criteria established by the second provider that must be satisfied for the for the first provider to view a calendar of the second provider has been satisfied by the first provider; and displaying the calendar of the second provider to the first provider though a computer interface.

### BACKGROUND

It is a common practice for busy professionals to share their calendars. Typically calendar sharing is done one of two ways. One is by delegating tasks to an assistant to take from external users and create appointments as he thinks appropriate. This is completely manual process. Users may also share calendars with external users to create appointment requests and ask for a confirmation from the personal assistant.

A challenge presented by most attempts towards an automated appointment system is that, in practice, a professional utilizes numerous selection and acceptance criteria which are more complex than simply sharing available slots to the external world. In practice, it is common for a professional, despite being interested in participating in an automated appointment system, is only willing allow only a defined subset of external users to send appointment requests. Professionals often impose some preference criteria on the subject matter of the appointment. Disclosed is a system and method to incorporate all these preference-criteria.

### SUMMARY

Disclosed is a system and method for managing calendar sharing among multiple users. The system includes numerous embodiments including a decentralized system, a centralized system, and a hybrid system.

Disclosed are user friendly and logical criteria that maximize the chance of referral acceptance by a chosen specialist in a care coordination process.

In a healthcare setting, the criteria that may be utilzed include a trusted physician to physician relationship; volume of referrals between these physicians; patient type in terms of eligibility criteria and patient referral status; and allotted pre-defined appointment slots.

In certain embodiments, the selection criterion enables appointment confirmation by the chosen specialist in the care coordination system.

The disclosed system and method of sharing appointment schedules between providers enable providers with the ability to show which specialists are willing to take a new appointments once a calendar meeting or appointment is scheduled. While certain embodiments are directed to applications in the healthcare setting, the disclosed system and method will have utility in any environment where sharing of calendars or managing referrals is beneficial.

### BRIEF DESCRIPTION OF THE DRAWINGS

FIG. 1 illustrates a representative embodiment of a computerized system for conditionally sharing calendars with referring providers.

FIG. 2 illustrates a representative embodiment of a computerized method to determine eligibility criteria for providing access to a provider's calendar.

FIG. 3 illustrates a representative embodiment of a computerized method to determine whether a provider will be given access to a provider's calendar over a non-centralized system.

FIG. 4 illustrates a representative embodiment of a computerized method to determine appointment eligibility over a centralized system.

FIG. 5 illustrates a representative embodiment of a computerized method to determine appointment eligibility over a hybrid system.

### DETAILED DESCRIPTION

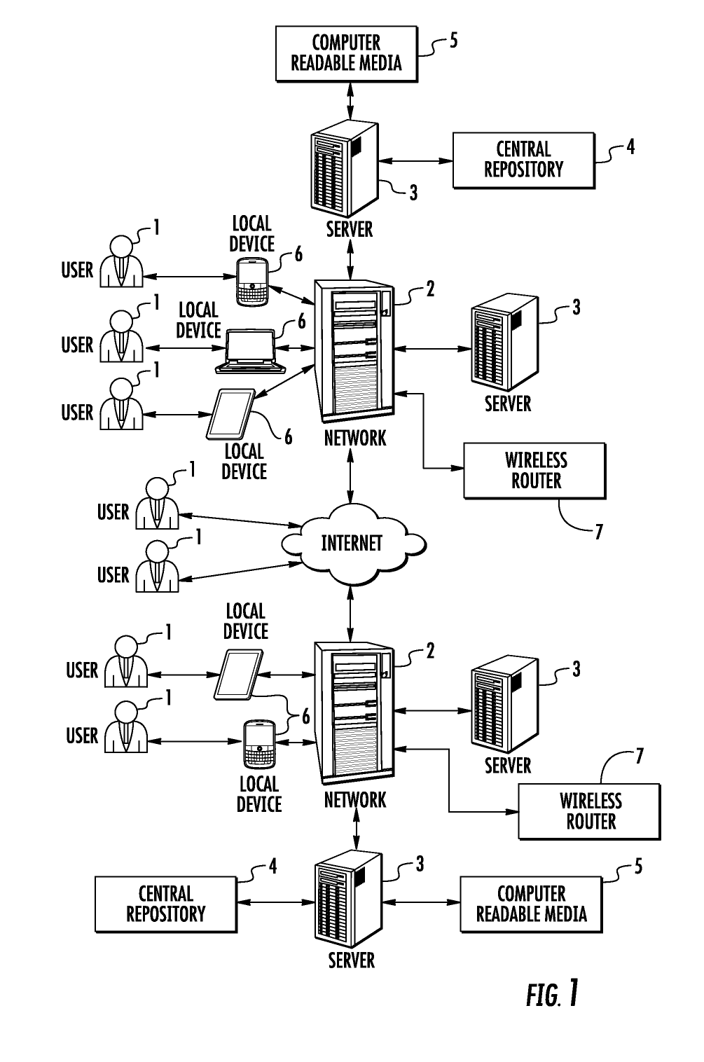

Disclosed is a system and method for conditionally sharing a calendar with referring providers. In certain embodiments, the system comprises an electronic health record (EHR), through which users are able to transmit data to other users through the system. FIG. 1 illustrates a representative embodiment of the disclosed system. Users 1 connect to a network 2 through a local device 6. In certain embodiments, users 1 will use their local device 6 to connect to a wireless router 7. In such embodiments, the wireless router is coupled to one or more networks. Alternative embodiments comprise one or networks 2, which may be optionally coupled to the Internet. In certain embodiments, each of the networks 2 will utilize various security features to ensure the security and integrity of the system and data transmitted over the system. In certain embodiments, each network 2 will utilize secure connections (for example, Secure Sockets Layer, Transport Layer Security, Virtual Private Networks, dedicated private networks, or Secure/Multipurpose Internet Mail Extensions). The system comprises one or more servers 3, each server 3 coupled to one or more networks 2. In certain embodiments, one or more servers 3 are coupled to the Internet. In certain embodiments, each server 3 will be protected by one or more firewalls. Further, data on each server may be encrypted. In certain embodiments, non-transitory computer readable media 5 encoding instructions for carrying out various methods is coupled to one or more servers 3. Users connect to the system servers through various devices 6 having connections to one or more networks 2. In alternative embodiments, users may access the system through local area networks, telephonic devices, radio frequencies, computers, or other electronic devices. In certain embodiments, data obtained through, and transmitted over the system resides on one or more central repositories 4. The one or more central repositories 4 may be associated with thin or thick clients where data transmitted through the system will be synchronized. In certain embodiments, all data transmitted and displayed to users resides on the central repository 4. Additionally system settings, including criteria set forth by users resides in the central repository as non-transitory 4, computer readable instructions.

Each user 1 is provided with an account. All information associated with each account is stored on the central repository 4. Users 1 access their accounts by supplying a user name and password through user interface, displayed on a device, coupled to a network. After logging on to the system and accessing their accounts, users have the ability to establish settings based on numerous criteria set forth herein. All settings are stored on one or more central repositories 4. Also stored on the central repository, is a database and directory of all providers in the network.

In healthcare settings, when a provider (“provider” and “user” are used interchangeably) is looking for another provider of certain type or specialty, or another provider to refer one of his patients and schedule appointment, the disclosed method enables providers to find free-slots of all the appropriate specialists based on certain criteria.

In certain embodiments, an audit trail will be established in the central repository to validate appointment schedules. This audit trail records which users is accessing the system, what information is viewed, and what actions are taken by each user.

In certain embodiments, trusted provider to provider relationships establish a basis for sharing of calendars between providers. In such embodiments, a first provider may elect to share his calendar with other providers with whom the first provider has already built a trusted relationship. Providers may attaint trusted provider status by being selected by another provider as “trusted” or by meeting criteria set forth by another provider. When a provider maintains a tight schedule it is common that the provider will not accept new referrals from other random other but may accept if it is sent by one of the trusted providers in the network. In such embodiments, a specialist's calendar will not be open to all providers in a given area, only a select group of providers in the community that the provider has chosen to trust.

Providers may select certain providers as “trusted” providers. In certain embodiments, a user will log onto the system, and through a user interface, select other users who will be given trusted status. Once trusted status is attained, the trusted provider may view the calendar of the provider who granted trusted status. In certain embodiments, trusted users may also schedule appointments on the calendars of users who have granted trusted status.

In certain embodiments, providers have the ability to specify rules and use the rules as filtering criteria when to determine with whom their calendar will be shared.

In addition to sharing calendar information, providers may also allow other providers to schedule appointments on a shared calendar if certain criteria are satisfied. In such embodiments, a first provider may refer a patient or client to a second provider by scheduling an appointment directly on the second provider's appointment calendar. In healthcare settings, patient appointments may be scheduled by a primary care physician (or a person acting on behalf of the primary care physician), on behalf of a patient, directly on the calendar of a specialist. Providers may establish specific criteria that must be satisfied before a referred patient or client may be scheduled. In certain embodiments, the system will have default settings that may use any or all of the criteria set forth herein to determine whether a provider may schedule an appointment on behalf of a referred client or patient. Once an appointment is scheduled, the appointment time is stored in the central repository and shared with, and accessible to, other users of the system.

Patient eligibility criteria may be used in certain embodiments in a healthcare setting to determine whether a provider may schedule an appointment directly on the calendar of another provider. In such embodiments, primary care providers will typically schedule an appointment with a specialist on behalf of a patient, but appointments may be scheduled with any type of provider. Patient eligibility may be determined on the basis of a patient's insurance coverage. For example, a provider may decline referrals for patients who have a health plan that the provider does not accept. Additionally, a provider may limit the number of referrals accepted for patients with a given health plan. For example, a provider may limit patients having a health plan with lower reimbursement rates to a certain number of referrals or to a certain number of referrals per unit of time (number of such referrals per month, per year, per quarter).

In other embodiments, the ability of a provider to schedule an appointment on another provider's calendar may depend on the choice of the provider for accepting any existing or new patient referral. Providers may stop taking new patients. Providers may also restrict new patients to a certain number of new patients per unit of time. Additionally, a first provider may only allow other providers to schedule appointments with patients with whom the first provider has an existing relationship.

In other embodiments, a referral will only be accepted if the referred patient already has an appropriate preauthorization from a health plan. In certain embodiments, prior authorizations may be stored, received and accessible on the central repository.

In certain embodiments, a provider may allow another provider to make a certain number of referrals. For example, a specialist may delegate a given number of appointment times to a given primary care physician. The primary care physician may then use the delegated number of appointment times for the specialist without requesting permission from the specialist to make the referral. Any excess referrals would then require approval of the specialist.

Certain embodiments allow a provider may choose to set aside a certain percentage of the appointment slots and make them available same day or next day appointments. This allows other providers to find an appointment slot for the immediate or urgent need of a patient or client. This also allows emergent or urgent referrals to be made, and helps ensure availability of a provider.

Certain embodiments facilitate referral acceptance and identify which specialists are willing to accept new patients with the help of the disclosed logic of calendar sharing in general between providers. This information may be displayed to referring providers through a user interface. Providers may schedule appointments only on the calendars of providers who are willing to accept a given patient.

Examples of a use of certain embodiments are below:

Example 1: A primary care provider generally refers cases to three specialists—B, C, D based on a trusted provider to provider relationship. It is found that specialists B, C and D are not accepting new patient appointments. In such case the primary care provider can easily send his referral to specialist E, whom he refers patient occasionally and Specialist—E is also ready to take new patient appointments. In this way a new trust relationship has been established between the primary care provider and Specialist E, though both do not share a trusted network. This new trust relation is now seeded in the centralized database and periodically refreshed.

Example 2: A directory contains five hundred providers out of which Provider A is willing to consider referrals from only nine others from his trusted groups in the directory. In such instances, the nine providers can view Provider A's calendar as a local practice management system will allow him to do so.

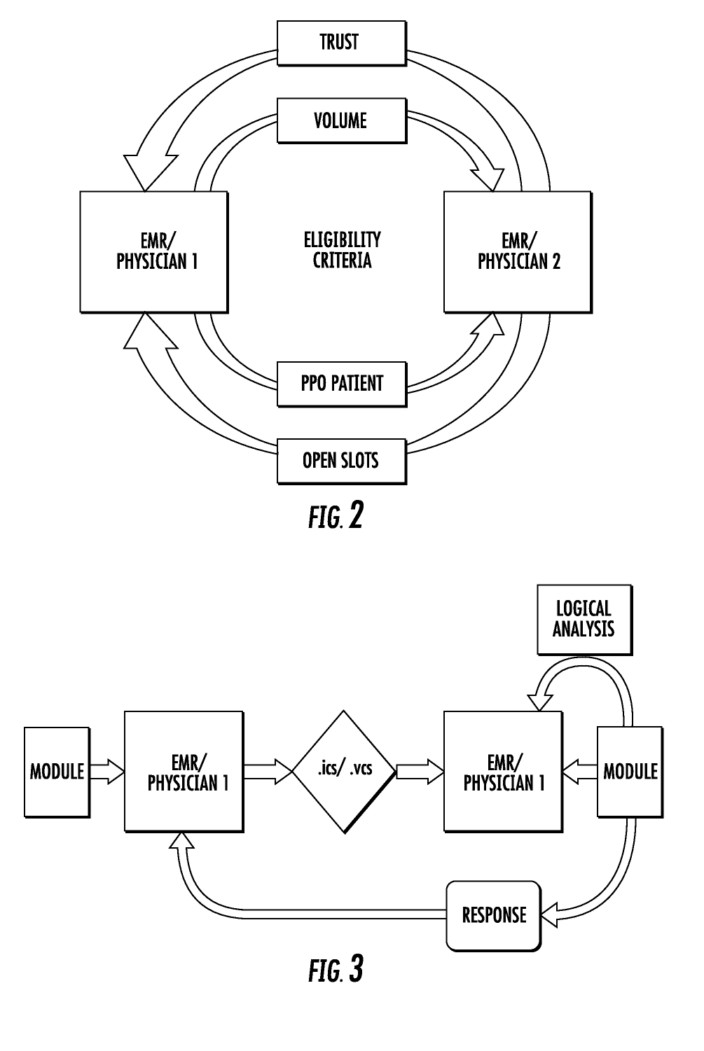

FIG. 2 illustrates an embodiment of data flow and flow of referrals in the disclosed system in a healthcare setting. In this embodiment, data flows between the Electronic Medical Records of a first physician 8 and a second physician 9. A physician's trust level 10 can be a criterion that may allow or preclude a referral. Volume of referrals 11 may also be a criterion for acceptance of a referral. Patient eligibility criteria are exemplified in FIG. 1 by a patient having a PPO health plan 12. Finally, the existence of open slots 13 on the calendar of the physician receiving referrals is a final criterion may allow or preclude a referral.

The system can interface with users through architecture having of a non-centralized system, a centralized computer proxy, or a hybrid system.

In embodiments having a non-centralized system, an additional software module is designed and deployed as an extension to the existing calendar server of each user. FIG. 3 illustrates a representative embodiment of a non-centralized system to allow for referrals and calendar sharing. The software module 14 comprises an information system with a calendar functionality that uses an Application Programming Interface (API) compatible with the calendar server by using the calendar's native protocol. The logic designed would comprise any or all criteria set forth herein. The logical criteria will be packaged into the additional module which would be installed on top of the user's calendar server. These modules add further attributes to the calendar request which maximize the probability of referral acceptance by the chosen provider. The calendar requests are dispatched from a first user's calendar server 8 to a second user's calendar server 9 as Multipurpose Internet Mail Extensions (MIME) email attachments that extend the format of email to support and carry the described criteria as additional fields in the form of .ics and .vcs files 15. This request resides on the second user's calendar server 9 until a response 17 is generated. The response 17 generated, based on the content of the transmitted information if it fulfills the assigned logical criterion 16 of the second user, either grants permission to view the second user's calendar availability, denies permission to view the second user's calendar, or holds the request in quarantine. The response from the second user is transmitted back to the first user. This module also synchronizes the calendars of the involved user with respect to any changes made thereafter by generating updated .ics/.vcs files 15.

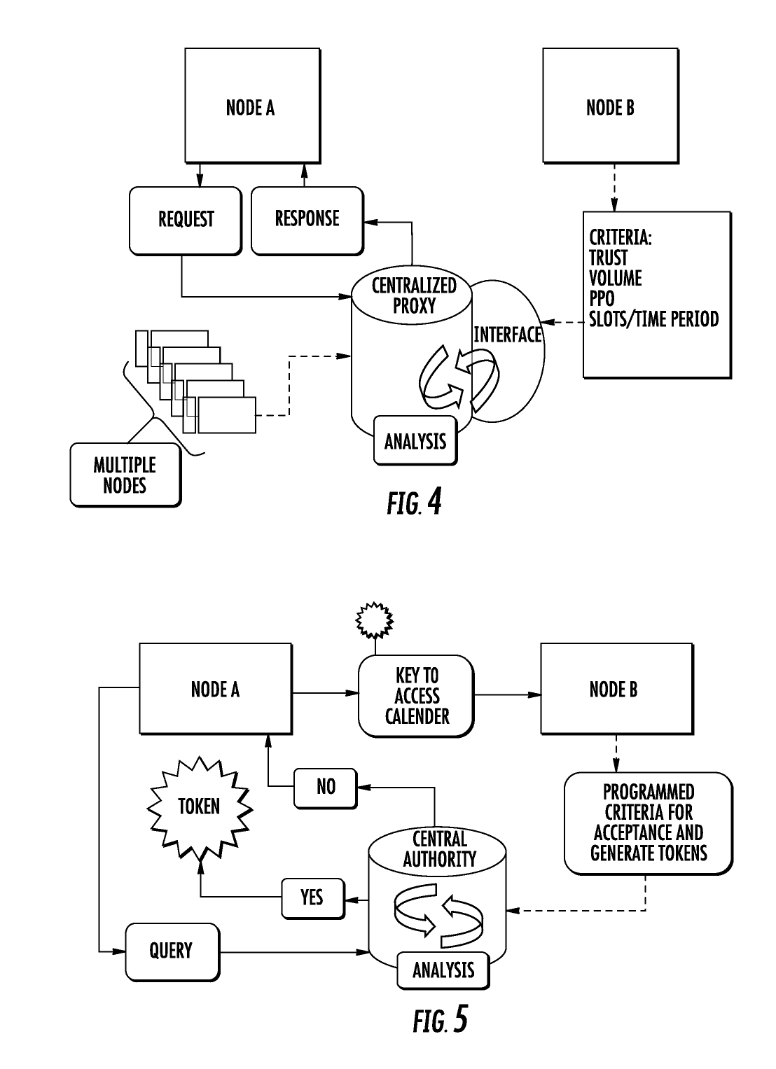

FIG. 4 illustrates a representative embodiment of a centralized system to allow for management of referrals and calendar sharing. FIG. 4 illustrates a centralized system which uses one master calendar proxy for a large health system, but the scope of the invention is not limited to healthcare. The proxy is an information system by example of but not limited to, a HL7 Electronic Medical Record that interfaces with the calendar server of Node B 19 using its native protocol. Node A 18, and similar nodes 22 of a large organizations, have access to the central repository 23. The receiving node, Node B 19, designates a common yet specific logic describing the eligibility criteria to the central repository 23. The trust factor for calendar proxy by Node B 18 is established by many ways 24. The centralized system, acting as the proxy, passes the generated information through a central repository 23 avoiding direct delivery of calendar requests 20 from Node A 18 to Node B 19. Node A 18 transmits the information with all eligible criteria integrated as a package to the central repository 23. The repository either generates a response 21 in the form of a permission or rejection and transmits the response to Node A 18 if the conditions of the criterion designated by Node B 19 are satisfied or not satisfied, respectively.

FIG. 5 illustrates a representative embodiment of a hybrid system comprising of both a centralized and a non-centralized system in order to access the availability of a desired calendar server and make referrals between providers. The system comprises central repository 23 that stores the programmed criteria assigned or defined by Node B 19. This integrated logic is used to grant access by issuing a token 30 or other permission or ticket to Node A 18 via the central repository 23. When Node A 18 retrieves a token 30, if all eligibility criteria defined 31 by Node B 19 are satisfied, access is granted to the calendar of Node B 19. This method not only allows Node B 19 to set a program with customized eligibility criteria 31 at an external, trusted, central repository without having to personalize individual criteria for each of many nodes requesting permission to access its calendar, but also has a channel of direct communication with the requesting party after they pass the minimum eligibility criteria.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

What is claimed is:

1. A computerized method for conditionally sharing calendars between providers and managing referrals comprising the steps of:
supplying a user name and a password to a first provider though a computer network;
creating an account associated with the first provider and storing data associated with the account associated with the first user on a central repository;
supplying a user name and password to a second provider through the computer network;
creating an account associated with the second provider and storing data associated with the account associated with the second user on the central repository;
obtaining, through the computer network, criteria established by the second user that must be satisfied for the for the first provider to view a calendar of the second provider;
determining the criteria established by the second provider that must be satisfied for the for the first provider to view a calendar of the second provider has been satisfied by the first provider; and
displaying the calendar of the second provider to the first provider though a computer interface.

2. The computerized method for conditionally sharing calendars between providers and managing referrals of claim 1 further comprising the steps of:
obtaining, through the computer network, criteria established by the second user that must be satisfied for the first provider to schedule an appointment directly on the calendar of the second provider;
determining the criteria established by the second provider that must be satisfied for the for the first provider to schedule an appointment directly on the calendar of the second provider has been satisfied the first provider; and
allowing the first provider to schedule an appointment on the calendar of a second provider.

3. The computerized method for conditionally sharing calendars between providers and managing referrals of claim 2 further comprising the steps of:
obtaining from the second provider, through the computerized user interface, a selection that the first provider is a trusted provider;
determining that the first provider has satisfied the criteria established by the second provider that must be satisfied for the for the first provider to view a calendar of the second provider; and
determining that the first provider has satisfied the criteria established by the second provider that must be satisfied for the for the first provider to schedule an appointment directly on the calendar of the second provider.

4. The computerized method for conditionally sharing calendars between providers and managing referrals of claim 3 wherein the steps are performed over a non-centralized system.

5. The computerized method for conditionally sharing calendars between providers and managing referrals of claim 3 wherein the steps are performed over a centralized system.

6. The computerized method for conditionally sharing calendars between providers and managing referrals of claim 3 wherein the steps are performed over a hybrid system.

7. The computerized method for conditionally sharing calendars between providers and managing referrals of claim 2 further comprising the steps of:
receiving a preauthorization from a health plan; and
storing the preauthorization on the central repository;
wherein the criteria established by the second user that must be satisfied for the first provider to view a calendar of the second provider and the criteria established by the second user that must be satisfied for the first provider to schedule an appointment directly on the calendar of the second provider both comprise a preauthorization from a health plan.

8. The computerized method for conditionally sharing calendars between providers and managing referrals of claim 7 wherein the steps are performed over a non-centralized system.

9. The computerized method for conditionally sharing calendars between providers and managing referrals of claim 7 wherein the steps are performed over a centralized system.

10. The computerized method for conditionally sharing calendars between providers and managing referrals of claim 7 wherein the steps are performed over a hybrid system.

11. A computerized system for conditionally sharing calendars between providers and managing referrals comprising:
one or more computer networks;
a server coupled to the one or more computer networks;
a central repository coupled to the one or more networks;
a non-transitory computer readable media having computer readable instructions for carrying out the steps comprising:
supplying a user name and a password to a first provider though the one or more computer networks;
creating an account associated with the first provider and storing data associated with the account associated with the first user on the central repository;
supplying a user name and password to a second provider through the one ore more computer networks;
creating an account associated with the second provider and storing data associated with the account associated with the second user on the central repository;
obtaining, through the one or more computer networks, criteria established by the second user that must be satisfied for the for the first provider to view a calendar of the second provider;
determining the criteria established by the second provider that must be satisfied for the for the first provider to view a calendar of the second provider has been satisfied by the first provider; and
displaying the calendar of the second provider to the first provider though a computer interface.

12. The computerized system for conditionally sharing calendars between providers and managing referrals of claim 11 wherein the non-transitory computer readable media having computer readable instructions for carrying out steps further comprising:
obtaining, through the computer network, criteria established by the second user that must be satisfied for the first provider to schedule an appointment directly on the calendar of the second provider;
determining the criteria established by the second provider that must be satisfied for the for the first provider to schedule an appointment directly on the calendar of the second provider has been satisfied the first provider; and
allowing the first provider to schedule an appointment on the calendar of a second provider.

13. The computerized system for conditionally sharing calendars between providers and managing referrals of claim 12 wherein the non-transitory computer readable media having computer readable instructions for carrying out steps further comprising:
obtaining from the second provider, through the computerized user interface, a selection that the first provider is a trusted provider;
determining that the first provider has satisfied the criteria established by the second provider that must be satisfied for the for the first provider to view a calendar of the second provider; and
determining that the first provider has satisfied the criteria established by the second provider that must be satisfied for the for the first provider to schedule an appointment directly on the calendar of the second provider.

14. The computerized system for conditionally sharing calendars between providers and managing referrals of claim 12 wherein the non-transitory computer readable media having computer readable instructions for carrying out steps further comprising:
receiving a preauthorization from a health plan; and
storing the preauthorization on the central repository;
wherein the criteria established by the second user that must be satisfied for the first provider to view a calendar of the second provider and the criteria established by the second user that must be satisfied for the first provider to schedule an appointment directly on the calendar of the second provider both comprise a preauthorization from a health plan.
